(19) United States
(12) Patent Application Publication
(10) Pub. No.: US 2010/0265800 A1
(43) Pub. Date: Oct. 21, 2010

(54) Array shape estimation using directional sensors

(76) Inventor: Graham Paul Eatwell, Annapolis, MD (US)

Correspondence Address: Graham Eatwell, 6 Southgate Court, Annapolis, MD, 21401, US

(21) Appl. No.: 12/798,882

(22) Filed: Apr. 13, 2010

Related U.S. Application Data
(60) Provisional application No. 61/212,848, filed on Apr. 16, 2009.

(51) Int. Cl. G01S 3/80

(52) U.S. Cl. 367/127; 367/129

(57) ABSTRACT

A method and apparatus for estimating the positions of sensors in an array of connected sensors. The sensors are operable to sense a propagating phenomenon, such as an acoustic disturbance in water or air. For each sensor i in the array of connected sensors, the direction vector dᵢ that corresponds to a direction of propagation between a reference point and the sensor i is measured. The position of the sensors relative to the reference point are determined dependent upon the vectors dᵢ. Additional information, such as propagation time, sensor orientation, and/or the lengths of the connections between sensors may be used. Optionally, the direction d are found using a singular value decomposition of a matrix formed from vectors of sampled signals components.

### CROSS REFERENCE TO RELATED APPLICATIONS

This application claims priority to provisional application Ser. No. 61/212,848, titled “Improved Array Shape Estimation Using Directional Acoustic Sensors”, filed 16 Apr. 2009.

### BACKGROUND

The gathering of data in an acoustic environment by means of an array of electrically interconnected acoustic sensors is important for commercial and military purposes. Passive sonar arrays that incorporate omni-directional hydrophones have been used for many years in applications such as geologic surveys and submarine detection and tracking. An array is essentially an assembly of acoustic sensors held together by a strength member and moved through water by a platform such as a ship or submarine to detect sound signals in the water. Such sensors are useful for detecting the position of underwater sonar target contacts. Towed arrays of acoustic sensors are long, continuous, neutrally buoyant hose lines, often several hundred meters long, which periodically contain numerous acoustic sensor receivers. Typically, these elongated arrays have a number of acoustic sensor elements in modules or clusters, along with their associated electronics and control leads, contained within the hose-shaped structure that extends through the water. In order to gather data in an ocean environment, one end of a linear acoustic sensor array is coupled to a navigating vessel. The principle advantages of the towed array are that it is separated from noise generated by the towing platform, allowing for improved detection of low source level signals, and that it can be constructed so that it is significantly longer than the towing platform, allowing for detection of lower frequency signals and for better bearing accuracy.

The individual acoustic sensors cooperate or interact to provide a beam, which may be steered to determine the bearing from the array of various acoustic targets. The acoustic sensors are connected to suitable electronics on the towing vessel which indicates the bearing of an identified underwater target. Exemplary towed arrays are described in U.S. Pat. Nos. 4,554,650 and 5,412,621. In locating submerged bodies, sonar is either used passively, through reception of signals sent through water by the target, or actively wherein a pulse of sound is sent into the water by a sonar projector. The sound is then reflected back from the target and detected by the acoustic sensor arrays as an echo. This echo is received as acoustic energy by an acoustic transducer, converted into electrical energy, and read by a computer on the vessel to determine the location of objects within the water. As shown in U.S. Pat. No. 5,844,860, elongated, hose-like towed arrays of acoustic sensors attached to the rear end of towed bodies are commonly used for the acoustic sensing of moving objects within the ocean.

Methods for determining the positions of omni-directional hydrophones are described in U.S. Pat. No. 4,992,990 and U.S. Pat. No. 5,166,905. These methods use multiple acoustic sources and triangulation to estimate the sensor positions. The method described in U.S. Pat. No. 4,992,990 also uses compass information.

More recently, arrays using directional acoustic sensors have been developed.

Acoustic arrays are also using for target location in air.

Operation of an array involves combining sensors signals dependent upon the relative locations of the sensors. Generally this allows desired signals to be combined with similar phase or timing and thereby reinforced, while causing undesired signals to cancel. This, in turn, requires that the sensor locations or, equivalently, the shape of the array, be known.

### BRIEF DESCRIPTION OF THE DRAWINGS

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of an exemplary sensor array in accordance with some embodiments of the invention.

FIG. 2 is a diagram illustrating array geometry and notation.

FIG. 3 is a diagrammatic representation of a section of an exemplary sensor array in accordance with some embodiments of the invention.

FIG. 4 is a further diagrammatic representation of a section of an exemplary sensor array in accordance with some embodiments of the invention.

FIG. 5 is a diagram illustrating propagation directions in accordance with some embodiments of the invention.

FIG. 6 is a diagram illustrating sensor orientations and array shape in accordance with some embodiments of the invention.

FIG. 7 is a block diagram of an exemplary sensor array and associated array processing system in accordance with some embodiments of the invention.

FIG. 8 is a flow chart of a method for determining propagation directions in accordance with some embodiments of the invention.

FIG. 9 is a block diagram of an exemplary array data processor in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### SUMMARY

In one embodiment, the positions (in two or three dimensions) of one or more sensors in an array of sensors, are determined by:
(1) measuring the vector directions dᵢ from a reference point (such as a reference source or receiver) to the sensor in the known frame of reference, and
(2) estimating the position of the sensor along the vector dᵢ (i) estimating the distance between the sensor and the reference point or (ii) fitting a curve between adjacent sensors using the orientation of the sensor and the connection length between sensors.

The vector directions may be referenced to a fixed spatial frame of reference by measuring the orientation of the sensor relative the frame of reference (using gravity and magnetic field sensors, for example),

The reference point may be a source position (such as towed seismic source, a source on the towing platform, or a source on another sensor). Alternatively, the reference point may be a receiver (such as receiver on the towing platform).

For an in-water array, the reference point may be a tail-float at the end of the array. The position of the tail float can be determined by known methods (such as positioning using a Global Positioning Satellite system).

The reference point may be any of the sensors in the array or a source on the array.

In order to measure vector directions dᵢ from a reference point to the sensor, the sensor may be a directional sensor that responds to an acoustic source at the reference point, or a directional sensor may be positioned at the reference point with an acoustic source at the sensor. For example, for simple omni-directional hydrophone sensors, the hydrophones can be used a sources and sensed by a directional sensor at the reference point, or the sensors can be directional sensors (such as tri-axial accelerometers, as disclosed in U.S. Pat. No. 6,370,084, or clusters of pressure sensors, or arrays of pressure sensors, or combinations thereof).

### DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

One aspect of the present invention relates to a method and apparatus for estimating the positions of sensors in an array of connected sensors. The sensors are operable to sense a propagating phenomenon, such as an acoustic fluctuation in water or air. For each sensor i in the array of connected sensors, the orientation of the sensor, relative to a spatial frame of reference, is measured, as is a direction vector dᵢ that corresponds to a direction of propagation of the phenomenon between a reference point and the sensor i. The sensor is assumed to be located on a vector in the direction dᵢ that originates from the reference point. Various techniques may be used for estimating the position of the sensor i along the vector dᵢ. In one embodiment. the position of the sensor along the direction vector dᵢ is found by estimating the distance between the sensor i and the reference point dependent upon the propagation time between the reference point and the sensor i.

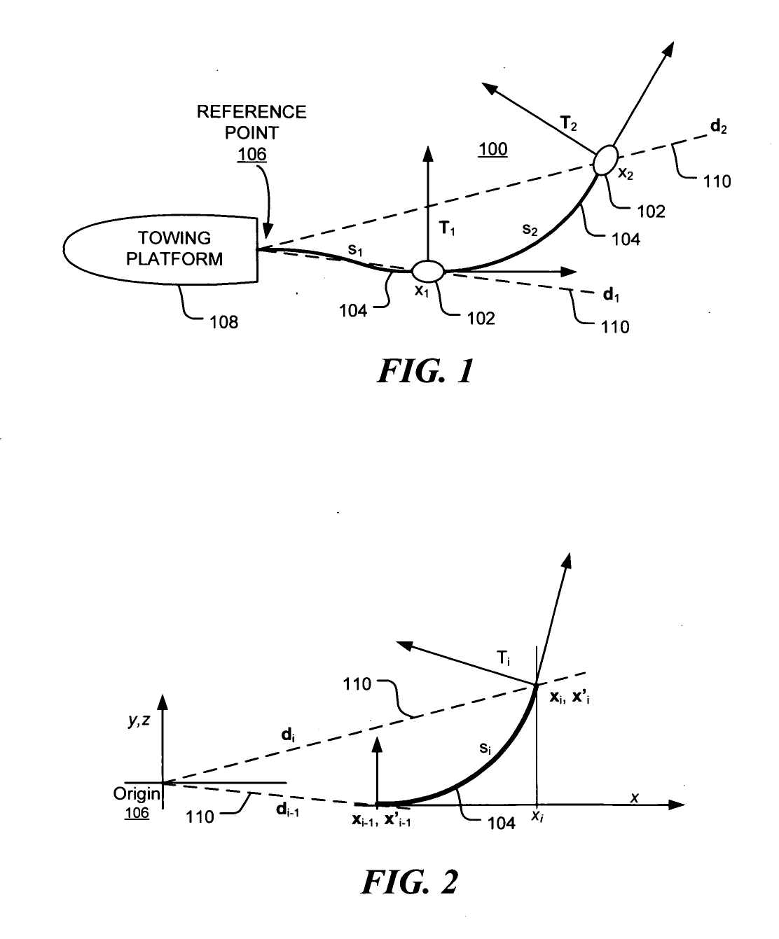

An exemplary array 100 having just two sensors is shown in FIG. 1. In FIG. 1, the array has sensors 102 positioned at locations x₁ and x₂. The sensors are connected by connections 104 that form part of the towing structure of the array. In the embodiment in FIG. 1, the reference point 106 is located on a towing platform 108. The directions propagation between the reference point 106 and the sensors 102 are indicated by broken lines 110. From the figure, it can be seen that the sensors are located on the lines 110. Further, the length s₁ of the connection 104 between the two sensors is substantially fixed and the orientation of the sensor is in a fixed relation to the curve of the array towing structure. Still further, the propagation time between the reference point and the sensors may be measured. Some or all of this information may be used to estimate the sensor locations.

In applications where the speed of propagation varies within the medium, the direction vector dᵢ corresponds to a ray path along which the disturbance propagates between the reference point and the sensor i.

In a further embodiment, the position of the sensor along the direction vector dᵢ is found by fitting a parametric curve between two or more sensors. The curve is constrained by the orientations of the sensors and the length of a connector between connected sensors.

The propagating phenomenon may be generated by activating a source located at the reference point and sensed by a directional sensor in array that enables the direction vector to be measured.

In a further embodiment, the propagating phenomenon is generated by activating a source at one or more sensor positions. In this embodiment, the direction vector dᵢ may be measured using a directional sensor located at the reference point. The sources may be activated in turn, or at different frequencies, or driven by orthogonal signals.

Some sensors, such as hydrophones, may be operated as a source by apply a drive signal. Thus, one or more sensors in the array itself may be used a sources.

A further aspect of the present invention relates to an improved method and apparatus for measuring the direction vector dᵢ. In one or more embodiments, directional components of the phenomena are sensed to produce a signal for each of the directional components. These signals are sampled to produce a vector of sampled signals for each of the directional components. The sampled signals are then processed by a data processor. For each of a number of time windows, a matrix is formed from the vectors of sampled signals corresponding to a time window of the plurality of time windows. The singular values of the matrix are identified and a time window is selected for which one of the singular values is significantly larger than the other singular. When one singular value is dominant, it is likely that the signal is propagating in a single direction and is therefore free from reflections or other interference. The direction vector dᵢ is then determined from the vectors of sampled signals corresponding to the selected time window. The relative levels of the singular values provide a confidence measure for the result.

In one embodiment, the singular vector corresponding to the largest singular value of the matrix formed from the vectors of sampled signals corresponding to the selected time window may be used to determine the direction vector.

In one embodiment, data from an array of connected sensors that sense propagating phenomena, such as sound, is processed in a system that includes an input for receiving sensor orientation data from the array of connected sensors, an input for receiving sensed data corresponding to a propagating phenomenon, a data processor, and an output for outputting data dependent upon the positions of the connected sensors. The data processor is operable to (i) process the sensor orientation data, and the data, to provide estimates of the propagation directions relative to each sensor of the array of connected sensors, (ii) estimate the distances from a reference point to each sensor of the array of connected sensors along a corresponding propagation direction, and (iii) determine the positions of the connected sensors relative to the reference point dependent upon the propagation directions and the distances from the reference point.

The system may also include a signal generator operable to provide a signal to drive a source to generate the propagating phenomenon.

In one embodiment, the output is a graphical representation of the shape of the array of connected sensors. In a further embodiment, the output is an estimated source location or bearing that is calculated dependent upon the positions of the sensors.

Several exemplary embodiments of the present invention, as applied to an array of acoustic sensors, are described in more detail below. Other embodiments that use sensed data relating to the direction of propagation of a propagating phenomenon to estimate sensor locations will be apparent to those skilled in the art. The propagating phenomenon may be an acoustic fluctuation, in air or water or other media for example. However, the present invention has application to other propagating phenomena, including, but not limited to, electromagnetic or optical signals.

In a first embodiment, an acoustic array consists of a number of connected directional acoustic sensors at positions. The position of sensor with index i is denoted as xᵢ={xᵢ, yᵢ, zᵢ}. In the case of an underwater towed array, the sensors are connected by a towing structure, such as a hose, that is normally under tension. In this case, the distance sᵢ, measured along the towing structure between the sensor at xᵢ₋₁ and xᵢ is known.

The orientation of each directional acoustic sensor is assumed to be known, and may be measured, for example, using gravity and magnetic field sensing elements within or coupled to the sensors. This orientation is assumed to be at a fixed orientation relative to the towing structure. For example, the direction may define a tangent to the towing structure at the sensor position.

Sound from a source at a reference point can be measured by each directional acoustic sensor. The reference source position is taken as the origin, x={0,0,0}. This gives a direction −dᵢ from the sensor to the towing platform. Equivalently, the directional acoustic sensor is in the direction dᵢ from the reference acoustic source.

In a further embodiment, a directional sensor is positioned at the reference point. In this embodiment the sensors in the array may be directional or non-directional sensors.

Finally, the distance between the reference source and the directional acoustic sensor can be estimated using the acoustic propagation time or other techniques (such as optical or electromagnetic ranging techniques).

A two-element towed array is shown in FIG. 1. Generally, an array may have any number of sensors. Also, more than one array can be towed, as in the case of seismic streamers. Referring to FIG. 1, the array 100 includes sensors 102, whose positions are to be found, and connections 104 that connect adjacent sensors. The connections may be sections of a flexible cylindrical tube or hose that houses the sensors. In FIG. 1, the reference point 106 (which may be a source or a receiver) is at a towing platform 108. However, the array elements 102 at locations x₁ and x₂ may include both sensors and sources (or transducers, such as hydrophones, which can operate as either sensor or source).

### Problem Statement

In an embodiment for which the array includes directional sensors for which the orientations may be measured, the problem may be stated as: Given a set of tangents to a curve (sensor orientations) x′ᵢ={x′ᵢ, y′ᵢ, z′ᵢ}, estimate a set of points (sensor positions) xᵢ={xᵢ, yᵢ, zᵢ}, such that a curve u (x, y, z) (the towing structure) passing through the points has tangents values as the points and that the distance along curve (the connection length) from the point xᵢ₋₁ to the point xᵢ is sᵢ.

FIG. 2 shows the geometry of an exemplary array. Referring to FIG. 2, the direction of propagation 110 between the reference point 106 and sensor i is denoted as dᵢ, and the location of sensor i is denoted as xᵢ. If the reference point 106 is assumed to be at the origin of the coordinate system, the sensors locations are therefore constrained such that

xᵢ=|xᵢ|dᵢ,

where dᵢ is a unit vector. The length of the connector 104 to sensor i is denoted as sᵢ. The sensor location xᵢ may be found by measuring dᵢ, and estimating |xᵢ|.

### Fixed Frame of Reference

One aspect of the present invention is the measurement a of direction vector dᵢ (110) corresponding to a direction of propagation of the propagating phenomenon between a reference point (106) and a sensor i (102). In one embodiment, this measurement is achieved by use of a directional sensor. If the directional sensor is at the reference point, the orientation of the sensor may be known or unknown. If the directional sensor is a sensor in the array of sensor, the orientation is generally unknown. In either case, one method for determining the orientation of the acoustic sensor is to use gravitational and magnetic field (compass) sensors that are in a fixed orientation relative to the acoustic sensor. For example, the directional sensor may include three tri-axial sensors—the acoustic sensor itself (such as an accelerometer), a gravity sensor (which senses gravitational and inertial forces) and a magnetic field sensor. In order for these sensors to be used together, the sensors should be calibrated and aligned within a single frame of reference. The frame of reference may, for example, be taken to be the frame of reference of the direction sensor (e.g. an accelerometer). The Earth's gravitation and magnetic fields provide a substantially fixed frame of reference.

In operation, a directional acoustic sensor provides three signal components, denoted by the vector a relative to the local axis of the sensor. For operational use, these components may be converted to component a_{fixed} relative to a fixed frame of reference. In the example now described, the fixed frame of reference is chosen to be defined by the directions ‘North’, ‘West’ and ‘Up’. The magnetic field sensor measures the earth's field, so North and West are actually magnetic North and magnetic West. Other frames of reference may be used.

Manufacturing tolerances may result in misalignment of the axes of the three sensors. This misalignment should be compensated for, in order that the sensor data can be referenced to the fixed axes.

The ‘Up’ Direction

A unit vector u in the ‘up’ direction can be calculated from the measured gravitational vector g in the frame of reference of the tri-axial accelerometer, as

$$u = - \frac{g}{\vert g \vert} .$$

The ‘up’ component of the acceleration vector a is given by αᵤₚ=u^{T}a.

The ‘North’ Direction

Relative to the fixed directions, the earth's magnetic field is M{cosΨ,0,−sinΨ}^{T}, where Ψ is the angle of inclination and M is the field strength. The measured magnetic field vector m in the frame of reference of the tri-axial accelerometer is

m≡M(n cosΨ−u sinΨ).

The horizontal component (which is in the direction of ‘North’) is

mₕ=m−u(u^{T}m)=(1−uu^{T})m

and a unit vector in the ‘North’ is

$$n = \frac{{m}_{h}}{\vert {m}_{h} \vert} .$$

The ‘North’ component of a measured acoustic vector a is given by

αₙₒᵣₜₕ=n^{T}a.

The vertical component of the field is

mᵤₚ=u(u^{T}m_{α}),

hence the angle of inclination Ψ satisfies

tanΨ=−|mᵤₚ|/|mₕ|.

The ‘West’ Direction

The ‘West’ direction is given by

$$w = u ⊗ n = [ \begin{matrix}{u}_{y} {n}_{z} - {u}_{z} {n}_{y} \\ {u}_{z} {n}_{x} - {u}_{x} {n}_{z} \\ {u}_{x} {n}_{y} - {u}_{y} {n}_{x}\end{matrix} ] .$$

Note that when x is ‘north’ and z is ‘up’, y is ‘west’. The coefficient of West acceleration is

α_{west}=w^{T}a.

### Summary of Orientation Measure

In summary, in one embodiment of the invention, the basis vectors in the fixed frame of reference are calculated from the measured gravity and magnetic vectors g and m as

$$u = - \frac{g}{\vert g \vert}$$

$$n = \frac{m - u ( {u}^{T} m )}{\vert m - u ( {u}^{T} m ) \vert}$$

$$w = u ⊗ n$$

which define a rotation matrix

$$T = [ \begin{matrix}{u}^{T} \\ {n}^{T} \\ {w}^{T}\end{matrix} ] .$$

The acoustic signal vector a_{fixed} in the fixed frame of reference is calculated from the measured acoustic vector a as

a_{fixed}=Ta.

If the sound from a reference acoustic source is measured as the vector a, the direction d (in the fixed frame of reference) from the source to the sensor is given by

$$d = - \frac{Ta}{\vert Ta \vert} .$$

Having found the directions dᵢ, some exemplary methods for determining how far away the sensors are in these directions are now described.

### First Exemplary Solution Method—Using Propagation Time

The first exemplary solution method uses measurement of the distance between a reference point (such as a point on a towing platform) and each sensor. The distance may be estimated using the acoustic propagation time between a reference source (such as a source on the towing platform) and the sensor (or vice versa, using a source at the array sensor location and a sensor at the reference point).

If the acoustic propagation time tᵢ and sound speed c are known, the distance to the sensor can be simply estimated as

|xᵢ|=ctᵢ.

This gives the position of the sensor as

xᵢ=ctᵢdᵢ.

Alternatively, if the distance |xᵢ| is measured by some other ranging technique (such as optical or electromagnetic techniques), then the position is given by

xᵢ=|xᵢ|dᵢ.

The sensor position is found by measuring the direction vector dᵢ corresponding to a direction of propagation of the propagating phenomenon between a reference point and the sensor i and estimating the distance from the reference point to the sensor in that direction. FIG. 5 shows four exemplary direction vectors 110 emanating from a reference point at the origin. One the distance along the vector is known, the sensor position is determined.

If the direction vector is measured relative to the axes of sensor, the orientation of the sensor relative to a spatial frame of reference is also measured so that the direction vector can be found in a reference spatial frame. If the direction is measured by a directional sensor at the reference point, the orientation of the directional sensor should be known or measured.

If the distance cannot be estimated, for example if the propagation time tᵢ or sound speed c are unknown, or time synchronization between the source and the sensor signal cannot be achieved, the positions can be estimated by assuming that each segment of the array towing structure is described by a parametric shape with the appropriate gradient at each sensor position. This case will now be discussed.

### Second Exemplary Solution Method—Using Connection Lengths and a Single Reference Point

### Parametric Curve

To facilitate the description of this embodiment, it is assumed that coordinates may be rotated such the curve can be parameterized as a function of x. For most physical arrays, this can be done for each segment or for the whole array. Assuming dₓ≈0,

xᵢ=|xᵢ|dᵢ [symbol] xᵢ=|xᵢ|dₓ [symbol] |xᵢ|=xᵢ/dₓ [symbol] xᵢ=xᵢeᵢ

where

eᵢ=dᵢ/dₓ.

The curve has coordinates

p(x)=aα(x)+bβ(x)+cγ(x)+dδ(x)

where α,β,γ,δ are basis functions,

$$a = [ \begin{matrix}{a}_{y} \\ {a}_{z}\end{matrix} ] , b = [ \begin{matrix}{b}_{y} \\ {b}_{z}\end{matrix} ] , c = [ \begin{matrix}{c}_{y} \\ {C}_{z}\end{matrix} ] and d = [ \begin{matrix}{d}_{y} \\ {d}_{z}\end{matrix} ]$$

are parameter vectors and

$$p = [ \begin{matrix}y \\ z\end{matrix} ] .$$

The basis functions maybe determined from measurements of typical array shapes. For example, the method of principal components may be used to select the basis functions that most accurately model the array shape.

In this example, four basis functions are used, but a fewer or greater number of basis functions may be used.

In matrix form,

p=As(x),

where

$$A = [ \begin{matrix}a & b & \begin{matrix}c & d\end{matrix} ] and s = [ \begin{matrix}α ( x ) \\ β ( x ) \\ γ ( x ) \\ ϑ ( x )\end{matrix} ] .\end{matrix}$$

The gradient is given by

$${p}^{′} {=}^{Δ} \frac{d p}{d x} = {As}^{′} ,$$

where

$${s}^{′} {=}^{Δ} \frac{d s}{d x} = [ \begin{matrix}{α}^{′} ( x ) \\ {β}^{′} ( x ) \\ {γ}^{′} ( x ) \\ {ϑ}^{′} ( x )\end{matrix} ] .$$

One example of this type of curve has cubic line segments with coordinates

p(x)=ax³+bx²+cx+d.

The corresponding coordinate and slope vectors are

$$s = [ \begin{matrix}{x}^{3} \\ {x}^{2} \\ x \\ 1\end{matrix} ] and {s}^{′} = [ \begin{matrix}3 {x}^{2} \\ 2 x \\ 1 \\ 0\end{matrix} ] .$$

### End Point Constraints

For the i^{th} segment the end point positions and gradients satisfy

$${p}_{i - 1} {=}^{△} p ( {x}_{i - 1} ) = As ( {x}_{i - 1} )$$

$${p}_{i - 1}^{′} {=}^{△} \frac{d p}{d x} ( {x}_{i - 1} ) = {As}^{′} ( {x}_{i - 1} )$$

$${p}_{i} = {x}_{i} {e}_{i} = As ( {x}_{i} )$$

$${p}_{i}^{′} = {As}^{′} ( {x}_{i} )$$

so, in matrix form, the constraints can be written as

A[s(xᵢ) s′(xᵢ) s(xᵢ₋₁) s′(xᵢ₋₁)]=[xᵢeᵢ p′ᵢ pᵢ₋₁ p′ᵢ₋₁]

or

A(xᵢ)=[xᵢeᵢ p′ᵢ pᵢ₋₁ p′ᵢ₋₁]×[s(xᵢ) s′(xᵢ) s(xᵢ₋₁) s′(xᵢ₋₁)]⁻¹.

### Connection Length Constraint

The final piece of information is given either by (i) the time delay between source and receiver, or (ii) the constraint on the length of array between sensors. The former is much easier to calculate. The latter gives

∫ₓ_{_{i−1}}^{x}^{ᵢ} ds=sᵢ.

The line element is given by

$$\begin{matrix}d s = {( d {x}^{2} + d {y}^{2} + d {z}^{2} )}^{1 / 2} \\ = {[ 1 + {( \frac{d y}{d x} )}^{2} + {( \frac{d z}{d x} )}^{2} ]}^{1 / 2} d x \\ = {( 1 + \frac{d {p}^{T}}{d x} \frac{d p}{d x} )}^{1 / 2} d x \\ = {( 1 + \frac{d {s}^{T}}{d x} {A}^{T} A \frac{d s}{d x} )}^{1 / 2} d x ,\end{matrix}$$

so the line length is

$$\begin{matrix}I ( {x}_{i} ) = {\int }_{{x}_{i - 1}}^{{x}_{i}} {( 1 + \frac{d {p}^{T}}{d x} \frac{d p}{d x} )}^{1 / 2} d x \\ = {\int }_{{x}_{i - 1}}^{{x}_{i}} {( 1 + {s}^{′T} ( x ) {A}^{T} ( {x}_{i} ) A ( {x}_{i} ) {s}^{′} ( x ) )}^{1 / 2} d x\end{matrix}$$

where

A(xᵢ)=[xᵢeᵢ p′ᵢ pᵢ₋₁ p′ᵢ₋₁]×[s(xᵢ) s′(xᵢ) s(xᵢ₋₁) s′(xᵢ₋₁)]⁻¹

For a cubic curve, for example,

s^{T}(x)=[x³ x² x 1],

s′^{T}(x)=[3x² 2x 1 0].

Solution for Sensor Positions xᵢ

In one embodiment, the solution to the above equations is found iteratively using, for example, Newton's rule. A Taylor expansion of the line length for a current estimate \hat{x}ᵢ about the solution xᵢ gives

$$I ( {{x}^{⋒}}_{i} ) ≃ I ( {x}_{i} ) + ( {{x}^{⋒}}_{i} - {x}_{i} ) \frac{\partial I ( {{x}^{⋒}}_{i} )}{\partial {{x}^{⋒}}_{i}}$$

However, I(xᵢ)=sᵢ, so rearranging the above equation gives

$$( {x}_{i} - {{x}^{⋒}}_{i} ) \frac{\partial I ( {{x}^{⋒}}_{i} )}{\partial {{x}^{⋒}}_{i}} ≃ {s}_{i} - I ( {{x}^{⋒}}_{i} )$$

$${x}_{i} ≃ {{x}^{⋒}}_{i} - \frac{I ( {{x}^{⋒}}_{i} ) - {s}_{i}}{\partial I ( {{x}^{⋒}}_{i} ) \text{/} \partial {{x}^{⋒}}_{i}}$$

To avoid division by zero, this may be modified for small γ as

$${x}_{i} ≃ {{x}^{⋒}}_{i} - \frac{sign ( \partial I ( {{x}^{⋒}}_{i} ) \text{/} \partial {{x}^{⋒}}_{i} )}{max [ \vert \partial I ( {{x}^{⋒}}_{i} ) / \partial {{x}^{⋒}}_{i} \vert , γ ]} ( I ( {{x}^{⋒}}_{n} ) - {s}_{i} )$$

The gradient may be estimated as a first derivative to give

$$\frac{\partial I ( {{x}^{⋒}}_{i} )}{\partial {{x}^{⋒}}_{i}} ≃ \frac{I ( {{x}^{⋒}}_{n} ) - I ( {{x}^{⋒}}_{n - 1} )}{{{x}^{⋒}}_{n} - {{x}^{⋒}}_{n + 1}}$$

The iterative algorithm is

$${{x}^{⋒}}_{0} = {s}_{i} + {δ}_{0}$$

$${{x}^{⋒}}_{1} = {s}_{i} + {δ}_{1}$$

$${▽}_{n} = \frac{I ( {{x}^{⋒}}_{n} ) - I ( {{x}^{⋒}}_{n} )}{{{x}^{⋒}}_{n} - {{x}^{⋒}}_{n - 1}} , n \geq 1$$

$${{x}^{⋒}}_{n + 1} ≃ {{x}^{⋒}}_{n} - \frac{sign ( {▽}_{n} )}{max [ \vert {▽}_{n} \vert , γ \}} ( I ( {{x}^{⋒}}_{n} ) - {s}_{i} ) n \geq 1$$

which gives the sensor position \hat{x}ₙ₊₁.

### Third Exemplary Solution Method—Using Connection Lengths and Multiple Reference Points

In a third solution method, the directions dᵢ between sensors are measured (using an acoustic source on each sensor, for example). This allows the relative positions of the sensors to be determined using either the first or second solution method described above.

In particular, for the second solution method, an explicit solution can be found for an array shape modeled as a cubic curve.

For a cubic curve, with w=x−xᵢ₋₁, the end condition is given in matrix form

$$[ \begin{matrix}s ( {w}_{i} ) & {s}^{′} ( {w}_{i} ) & s ( 0 ) & {s}^{′} ( 0 )\end{matrix} ] = [ \begin{matrix}{w}_{i}^{3} & 3 {w}_{i}^{2} & 0 & 0 \\ {w}_{i}^{2} & 2 {w}_{i} & 0 & 0 \\ {w}_{i} & 1 & 0 & 1 \\ 1 & 0 & 1 & 0\end{matrix} ] ,$$

which has the inverse

$$[ \begin{matrix}s ( {w}_{i} ) & {s}^{′} ( {w}_{i} ) & s ( 0 ) & {s}^{′} ( 0 )\end{matrix} ] = [ \begin{matrix}- 2 & 3 {w}_{i}^{2} & 0 & 0 \\ {w}_{i} & - {w}_{i}^{2} & 0 & 0 \\ 2 & - 3 {w}_{i}^{2} & 0 & {w}_{i}^{3} \\ {w}_{i} & - 2 {w}_{i}^{2} & {w}_{i}^{3} & 0\end{matrix} ] \frac{1}{{w}_{i}^{3}} .$$

This gives the position vector p as

$$p ( {w}_{i} , w ) = As ( x ) = [ {e}_{i} \frac{{x}_{i}}{{w}_{i}} ( 3 - 2 \frac{w}{{w}_{i}} ) + {p}_{i}^{′} {w}_{i} ( \frac{w}{{w}_{i}} - 1 ) ] \frac{{w}^{2}}{{w}_{i}^{2}} + [ {p}_{i - 1} ( 2 \frac{w}{{w}_{i}} + 1 ) + {p}_{i - 1}^{′} {w}_{i} \frac{w}{{w}_{i}} ] ( \frac{w}{{w}_{i}} - 1 )$$

and the tangent vector as

$$\frac{\partial p ( w , {w}_{i} )}{\partial x} = [ 6 {e}_{i} \frac{{x}_{i}}{{w}_{i}} ( 1 - \frac{w}{{w}_{i}} ) + {p}_{i}^{′} ( \frac{3 w}{{w}_{i}} - 2 ) ] \frac{w}{{w}_{i}} + [ 6 \frac{{p}_{i - 1}}{{w}_{i}} \frac{w}{{w}_{i}} + {p}_{i - 1}^{′} ( 3 \frac{w}{{w}_{i}} - 1 ) ] ( \frac{w}{{w}_{i}} - 1 )$$

In terms of xᵢ and xᵢ₋₁, the tangent vector is

$$\frac{\partial p}{\partial x} = [ 6 {e}_{i} \frac{{x}_{i}}{{x}_{i} - {x}_{i - 1}} \frac{{x}_{i} - x}{{x}_{i} - {x}_{i - 1}} {p}_{i}^{′} ( 3 \frac{x - {x}_{i - 1}}{{x}_{i} - {x}_{i - 1}} - 2 ) ] \frac{x - {x}_{i - 1}}{{x}_{i} - {x}_{i - 1}} - [ 6 \frac{{p}_{i - 1}}{{x}_{i} - {x}_{i - 1}} \frac{x - {x}_{i - 1}}{{x}_{i} - {x}_{i - 1}} + {p}_{i - 1}^{′} ( 3 \frac{x - {x}_{i - 1}}{{x}_{i} - {x}_{i - 1}} - 1 ) ] \frac{{x}_{i} - x}{{x}_{i} - {x}_{i - 1}} .$$

Writing

$$r = \frac{x - {x}_{i - 1}}{{x}_{i} - {x}_{i - 1}}$$

gives

$$\frac{\partial p ( {x}_{i} , r )}{\partial x} = [ 6 {e}_{i} \frac{{x}_{i}}{{x}_{i} - {x}_{i - 1}} ( 1 - r ) + {p}_{i}^{′} ( 3 r - 2 ) ] r + [ 6 \frac{{p}_{i - 1}}{{x}_{i} - {x}_{i - 1}} r + {p}_{i - 1}^{′} ( 3 r - 1 ) ] ( r - 1 ) .$$

Setting xᵢ₋₁=0, which gives xᵢ₋₁=0 and pᵢ₋₁=0, gives

$$\frac{\partial p ( r )}{\partial x} = [ 6 {e}_{i} ( l - r ) {p}_{i}^{′} ( 3 r - 2 ) ] r + {p}_{i - 1}^{′} ( 3 r - 1 ) ( r - 1 ) ,$$

This is independent of xᵢ, so the length along the curve is given by

$$I ( {x}_{i} ) = {\int }_{{x}_{i - 1}}^{{x}_{i}} {( 1 + \frac{{d}^{T}}{d x} \frac{d p}{d x} )}^{1 / 2} d x = {x}_{i} {J}_{i} ,$$

where

$${J}_{i} ( {p}_{i}^{′} , {p}_{i - 1}^{′} , {d}_{i} ) = {\int }_{0}^{1} {( 1 + \frac{d {p ( r )}^{T }}{d x} \frac{d p ( r )}{d x} )}^{1 / 2} d r .$$

Hence, the solution for xᵢ is

$${x}_{i} = \frac{{s}_{i}}{{J}_{i}} . \qquad$$

More generally, the directions dᵢⱼ (and possible also the distances) between pairs of sensors, not necessarily adjacent sensors, can be measured and used to estimate the array shape using a combination of the techniques described above and triangulation techniques.

One way of doing this is to include an acoustic source, such as a hydrophone, with each sensor. U.S. Pat. No. 7,026,826 discloses a single direction sensor (a tri-axial accelerometer) that uses a hydrophone as both a source and a receiver. As a source it is used to calibrate the directional sensor with which it integrated. In one embodiment of the present application, the hydrophone is used as a reference source for other sensors in the array. In this manner, the directions (and also the distances) between sensors can be measured. One advantage of using a hydrophone is that it provides an additional acoustic sensor.

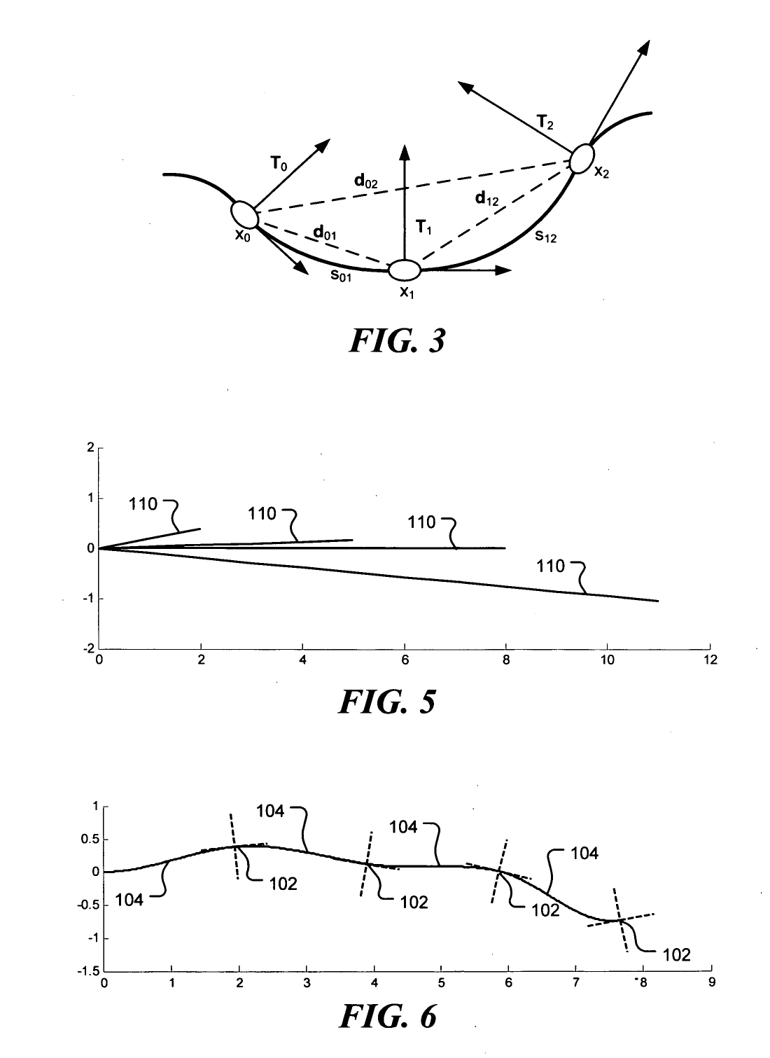

Using multiple sources, such as sources co-located with the sensors, provides a surplus of information. This can be used to more accurately determine the positions, since techniques such as least squares fitting may be used to estimate the sensor positions. For example, in FIG. 3 the position x₂ may be estimated:

1) from x₁ using d₁₂ and s₁₂,
2) from x₀ using d₁₂, d₀₂, s₁₂ and s₀₂,
3) from x₁ using d₁₂ and the propagation time
4) from x₀ using d₀₂ and the propagation time, or
5) as the intersection of the lines d_{12 and d}₀₂.

These methods may be combined to provide increased accuracy.

### Fourth Exemplary Solution Method—Unknown Reference Point (Target)

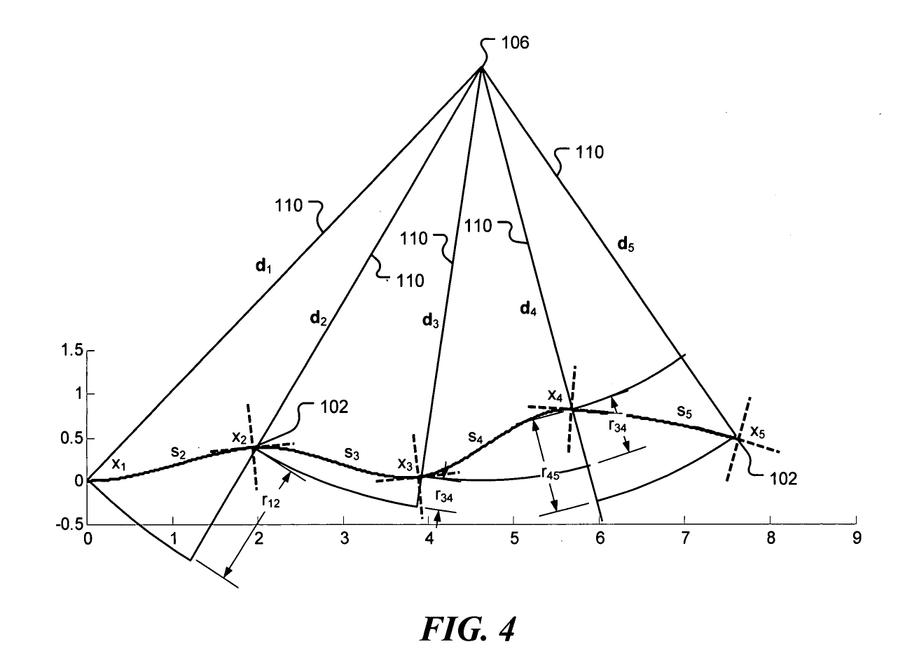

If the reference point is not on the array, an additional unknown is introduced. The geometry is illustrated in FIG. 4. The equations are as before, with

xᵢ=|xᵢ|dᵢ,

However, both |xᵢ₋₁| and |xᵢ| are unknown. If the time of arrival time tᵢ can be measured at each source, then

|xᵢ|−|xᵢ₋₁|=c(tᵢ−tᵢ₋₁)

Where (tᵢ−tᵢ₋₁) is referred to as the time difference of arrival. The equation can be rearranged as

$$\vert {x}_{i - 1} \vert = \vert {x}_{i} \vert - c ( {t}_{i} - {t}_{i - 1} ) = \vert {x}_{i} \vert - {r}_{i} = \frac{{x}_{i}}{{d}_{x}^{i} } - {r}_{1} = \frac{{x}_{i - 1}}{{d}_{x}^{i - 1}} .$$

This gives

$${x}_{i - 1} = ( {x}_{i} - {r}_{i} {d}_{x}^{i} ) \frac{{d}_{x}^{i - 1}}{{d}_{x}^{i}} ,$$

and hence

$$\begin{matrix}p ( {x}_{i - 1} ) = \vert {x}_{i - 1} \vert {d}_{i - 1} \\ = ( {x}_{i} - {r}_{i} {d}_{x}^{i} ) \frac{{d}_{i - 1}}{{d}_{x}^{i}} \\ = ( {x}_{i} - {r}_{i} {d}_{x}^{i} ) {e}_{i - 1} .\end{matrix}$$

Finally,

$${p}_{i - 1} {=}^{Δ} p ( {x}_{i - 1} ) = ( {x}_{i} - {r}_{i} {d}_{x}^{i} ) {e}_{i - 1} = As ( {x}_{i - 1} )$$

$${p}_{i - 1} {=}^{Δ} \frac{d p}{d x} ( {x}_{i - 1} ) = {As}^{′} ( {x}_{i - 1} )$$

$${p}_{i} = {x}_{i} {e}_{i} = As ( {x}_{i} )$$

$${p}_{i}^{′} = {As}^{′} ( {x}_{i} )$$

In matrix form, the constraints give

A[s(xᵢ) s′(xᵢ) s(xᵢ₋₁) s′(xᵢ₋₁)]=[xᵢeᵢ p′ᵢ pᵢ₋₁ p′ᵢ₋₁]

or

A(xᵢ)=[xᵢeᵢ p′ᵢ pᵢ₋₁ p′ᵢ₋₁]×[s(xᵢ) s′(xᵢ) s(xᵢ₋₁) s′(xᵢ₋₁)]⁻¹,

where

$${x}_{i - 1} = ( {x}_{i} - {r}_{i} {d}_{x}^{i} ) \frac{{d}_{x}^{i - 1}}{{d}_{x}^{i}} .$$

As before, the solution for xᵢ is given by solving

∫ₓ_{_{i−1}}^{x}^{ᵢ}(1+s′^{T}(x)A^{T}(xᵢ)A(xᵢ)^{_{′}}(x))^{1/2} dx=sᵢ, d₁, d₂, d₃, d₄.

A joint estimation may be used to give estimation of the array shape (sensor locations) and the target location. This method takes the form of an optimization subject to the constraints such as the length of array between sensors and any known locations (such as the attachment point of the array).

### Alternative Parameterization

The curve can be parameterized as a function of the distance along the curve. Using the following coordinate definitions

xᵢ(s)=∫₀^{s} cos (φ(s′))ds′+xᵢ₋₁

yᵢ(s)=∫₀^{s} sin (φ(s′)) cos (θ(s′))ds′+yᵢ₋₁

zᵢ(s)=∫₀^{s} sin (φ(s′)) sin (θ(s′))ds′+zᵢ₋₁

for arbitrary functions θ and φ, gives

$$\frac{d {x}_{i}}{d s} = cos ( ϕ ( {s}^{′} ) )$$

$$\frac{d {y}_{i}}{d s} = sin ( ϕ ( {s}^{′} ) ) cos ( θ ( {s}^{′} ) )$$

$$\frac{d {z}_{i}}{d s} = sin ( ϕ ( {s}^{′} ) ) sin ( θ ( {s}^{′} ) )$$

and

$${ds}^{2} = {( \frac{d {x}_{i}}{d s} )}^{2} + {( \frac{d {y}_{i}}{d s} )}^{2} + {( \frac{d {z}_{i}}{d s} )}^{2} = 1.$$

The line length is

s=∫₀^{s}ds′=s

as required. Furthermore, the gradient vectors are constant in the frame of reference of the sensor, so they are easily calculated in fixed frame of reference. The gradients and the end points give six equations and the vector constraint gives two more equations. The line integral constraint and the start point constraint are automatically satisfied. Thus, there are a total of eight equations.

The curve may be parameterized as

$$[ \begin{matrix}θ ( s ) \\ ϕ ( s )\end{matrix} ] = a α ( s ) + b β ( s ) + c γ ( s ) + d δ ( s )$$

and solved for a, b, c and d. The gradients give simple equations. The vector constraint is in terms of integrals, which can be simplified by appropriate choice of α, β, γ and δ.

### EXAMPLE RESULTS

Example results for a four-element towed array are shown in FIGS. 5 and 6. FIG. 5 shows the measured directions 110 from the reference point (at the position {0, 0}) to the sensors (the longer length line denoting the higher index). The x-coordinate is shown on horizontal axis and the y-coordinate on the vertical axis. These directions are measured by the sensors relative to a known coordinate frame (such as the directions magnetic north, magnetic west, and up). The distance along each line is determined either from a measurement of the propagation time from the towing source to the sensor, or by using knowledge of the connector length (e.g. the hose length) between sensors.

FIG. 6 shows the x and y coordinates of the array shape and sensor positions x₁, x₂, x₃, x₄ estimated assuming that the cable length between sensors in 2 units. The x-coordinate is shown on horizontal axis and the y-coordinate on the vertical axis. In this embodiment, the sensors are directional sensors at positions 102. The measured sensor orientations are denoted by the crosses. The reference source is at the position {0, 0}. Note that the array shape, shown by the connectors 104 is tangential to the sensor orientation at the sensor positions, as required.

### System

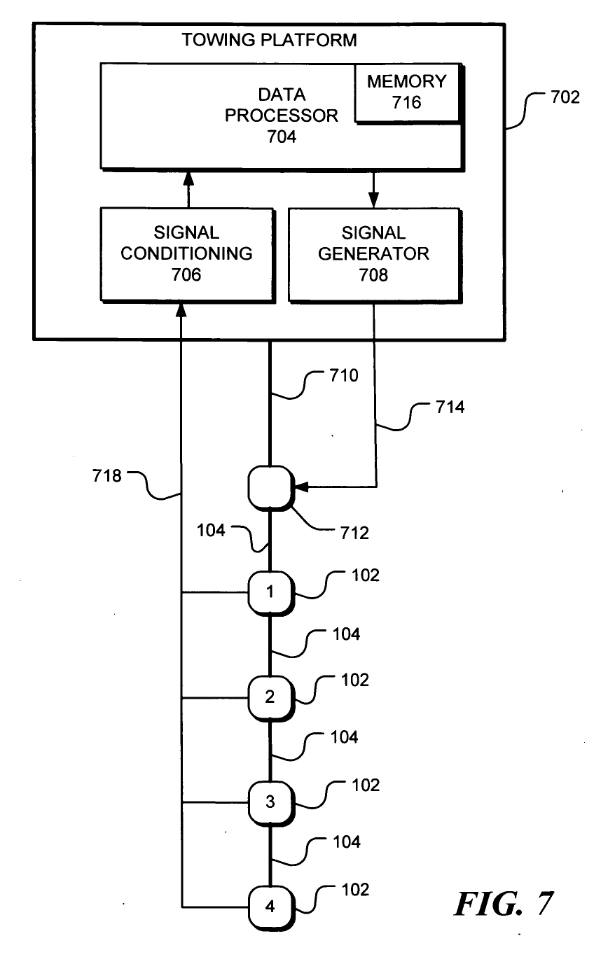

An example system incorporating array shape estimation is shown in FIG. 7. In this embodiment, the towing platform 702 includes a data processor 704, such as general purpose computer or an array processor, signal conditioning circuit 706 for receiving signals from the towed array and providing them to the data processor 704, and, optionally, signal generator 708. The towing structure, or hose, 710 couples an optional acoustic source 712 to the towing platform 702. The acoustic source 712 is driven by the signal generator 708 via signal connection 714. The signal generator 708 may be controlled by the data processor 704. In a further embodiment, the source 712 is mounted on the towing platform.

The towing structure 710 also couples multiple sensors 102 to the towing platform 702. The sensors 102 are coupled to the signal conditioning circuit 706 via signal paths 718. These may be analog or digital paths and are located within or adjacent to the towing structure 710. Wireless paths may also be used. The connections 104 between the sensors are provided by portions of the hose 710.

The data processor 704 operates to control the system and to process the data from the sensors to (a) determine the array shape and (b) process acoustic signals (to analyze acoustic targets or seismic reflections for example).

In one embodiment, the data processor 704 includes a memory 716 for storing a program of instructions that, when executed, perform one or more of the methods described above. The program of instructions may be distributed via computer readable media or via a computer network.

### Estimation of Acoustic Direction

The methods described above require that the acoustic direction be determined accurately. One problem in an underwater environment is that sound from a source arrives at a sensor via multiple paths, and therefore from multiple directions. One embodiment of the invention is a method and corresponding signal processing apparatus that may be used to separate the signal due to direct propagation from a signal due to reflected propagation. The method also provides an estimate of the direction of the direct propagation. The method may be used for sensor location and for subsequent target location using the sensor.

The method is described below with reference to an acoustic pressure wave, but equivalent methods may be used ofr other propagating disturbances.

The pressure due to a point source at a distance r from a directional sensor is

$$p = \frac{{e}^{i ( ω t - kr )}}{r} P$$

where ω is the radian frequency, k=ω/c, c is the sound speed and P is the source strength. The particle acceleration is

$$a = \frac{i ω}{ρ c} ( 1 - \frac{i}{kr} ) pd ,$$

where d is a unit vector in the direction from the source to the sensor. For distant sources

$$a ( t ) = \frac{1}{ρ c} \frac{\partial p ( t )}{\partial t} d$$

This shows that the acceleration vector, a, is in the direction d.

In a body of water, sound travels from the source to sensor over a direct path (which may be curved) and via paths that include reflections. The reflected sound generally arrives from a different direction than the direct sound. For a single reflection, the acceleration is

$$a ( t ) = \{ \begin{matrix}α ( t ) {d}_{i} & {t}_{1} < t < {t}_{2} \\ α ( t ) {d}_{i} + β ( t ) {d}_{r} & {t}_{2} < t\end{matrix}$$

Where dᵢ is a unit vector in the direction of the direct propagation and dᵣ is a unit vector in the direction of the reflected propagation

If the acceleration vector is sampled at time nT, the sampled vectors can be collected as the 3×N matrix

$$\begin{matrix}A ( N ) = [ \begin{matrix}a ( n ) & a ( n + 1 ) & a ( n + 2 ) & … & … & a ( n + N - 2 ) & a ( n + N - 1 )\end{matrix} ] \\ = [ \begin{matrix}{d}_{i} & {d}_{r} ] [ \begin{matrix}H ( nT - {t}_{1} ) & 0 \\ 0 & H ( nT - {t}_{2} )\end{matrix} ]\end{matrix} \times \\ [ \begin{matrix}α ( n ) & α ( n + 1 ) & α ( n + 2 ) & … & … & α ( n + N - 2 ) & α ( n + N - 1 ) \\ β ( n ) & β ( n + 1 ) & β ( n + 2 ) & … & … & β ( n + N - 2 ) & β ( n + N - 1 )\end{matrix} ]\end{matrix}$$

The matrix A(N) can be decomposed using a singular valued decomposition to give

$$\begin{matrix}A ( N ) = {UDV}^{′} \\ = [ \begin{matrix}{d}_{1} & {d}_{2} & {d}_{3}\end{matrix} ] [ \begin{matrix}{λ}_{1} ( N ) & 0 & 0 \\ 0 & {λ}_{2} ( N ) & 0 \\ 0 & 0 & 0\end{matrix} ] \\ [ \begin{matrix}\hat{a} ( n ) & \hat{a} ( n + 1 ) & \hat{a} ( n + 2 ) & … & \hat{a} ( n + N - 1 )\end{matrix} ]\end{matrix}$$

where, for nT<t₂, the singular vector dᵢ is equal to the acoustic direction dᵢ and the singular value λ₂(N) is zero or close to zero. The last matrix on the right hand side is a matrix normalized signal components. For nT>t₂, λ₂(N) is non-zero. Hence, a comparison of the singular values λ₁(N) and λ₂(N) may be used to detect the arrival of the reflected wave. For example, for increasing N, the ratio of λ₁(N) to λ₂(N) becomes large as the direct wave arrives, but then decreases rapidly as the reflected wave arrives. In one embodiment of the invention, the ratio

$$\frac{{λ}_{1}^{2} ( N )}{{λ}_{1}^{2} ( N ) + {λ}_{2}^{2} ( N )}$$

is used. When the ratio falls below a threshold value (such as 0.996 or thereabouts), it is an indication that more than one acoustic wave component is present in the signal.

In an alternative embodiment, the following matrix is consider:

$$\begin{matrix}C ( N ) = \frac{1}{N} {\sum }_{n = 0}^{N - 1} a ( n ) {a}^{T} ( n ) \\ = \frac{1}{N} {\sum }_{n = 0}^{N - 1} a ( n ) {a}^{T} ( n ) \\ = \{ \begin{matrix}{d}_{i} {d}_{i}^{T} \frac{1}{N} {\sum }_{n = 0}^{N - 1} {α}^{2} ( n ) & {t}_{1} < t < {t}_{2} \\ \frac{1}{N} {\sum }_{n = 0}^{N - 1} ( α ( t ) {d}_{i} + β ( t ) {d}_{r} ) {( α ( t ) {d}_{i}^{T} + β ( t ) {d}_{r}^{T} )}^{T} & {t}_{2} < t\end{matrix} \\ = \{ \begin{matrix}[ \begin{matrix}{d}_{i} & {d}_{2} & {d}_{3}\end{matrix} ] [ \begin{matrix}{λ}_{i}^{2} ( N ) & 0 & 0 \\ 0 & 0 & 0 \\ 0 & 0 & 0\end{matrix} ] [ \begin{matrix}{d}_{i}^{T} \\ {d}_{2}^{T} \\ {d}_{3}^{T}\end{matrix} ] & {t}_{1} < t < {t}_{2} \\ [ \begin{matrix}{d}_{i} & {d}_{2} & {d}_{3}\end{matrix} ] [ \begin{matrix}{λ}_{1}^{2} ( N ) & 0 & 0 \\ 0 & {λ}_{2}^{2} ( N ) & 0 \\ 0 & 0 & 0\end{matrix} ] [ \begin{matrix}{d}_{i}^{T} \\ {d}_{2}^{T} \\ {d}_{3}^{T}\end{matrix} ] & {t}_{2} < t\end{matrix}\end{matrix}$$

where

$${λ}_{i}^{2} ( N ) = \frac{1}{N} {\sum }_{n = 0}^{N - 1} {α}^{2} ( n )$$

$${λ}_{1}^{2} ( N ) = \frac{1}{N} {\sum }_{n = 0}^{N - 1} ( {α}^{2} ( n ) + {β}_{1}^{2} ( n ) ) , \\ {λ}_{2}^{2} ( N ) = \frac{1}{N} {\sum }_{n = 0}^{N - 1} {β}_{2}^{2} ( n )$$

d₂ is the component of dᵣ that is perpendicular to dᵢ, and d₃ is a vector that is perpendicular to both dᵢ and d₁. β₂ and β₃ are the corresponding components of the β. An eigenvalue analysis of the matrix C(N) and a comparison of the eigenvalues as a function of N allows the arrival time t₂ of the reflected wave to be determined, as well as the acoustic direction dᵢ of the direct wave.

This process may be used to separate the direct arrival from the reflected arrival. For example the ratio of singular values may be compared to threshold, or the peak ratio may be found. Additionally, the singular vector corresponding to the largest singular value provides an indication of the direction of the incident or direct sound wave. Thus, in an array processing system, a singular value decomposition of a matrix of sensor signals may be used to separate automatically the signals due to a direct sound wave from signals due to reflected sound waves and also used to identify the direction of the sound wave. Similarly, the first reflected sound wave may be separated from subsequent reflects. This process increases the accuracy of an array shape detection system in which the sensor positions are found relative to a known source, and also increases the accuracy of source location using a sensor or sensor array.

In one embodiment, a principal component analysis (PCA) of the signals is performed in place of the singular value decomposition. For example a PCA may be used to determine the two largest singular components and the corresponding singular values. PCA is well known to those of ordinary skill in the art and may be implemented using an adaptive network. In this context, the singular value decomposition and the PCA automatically steer the directional sensor towards the acoustic source, while rejecting components from perpendicular directions.

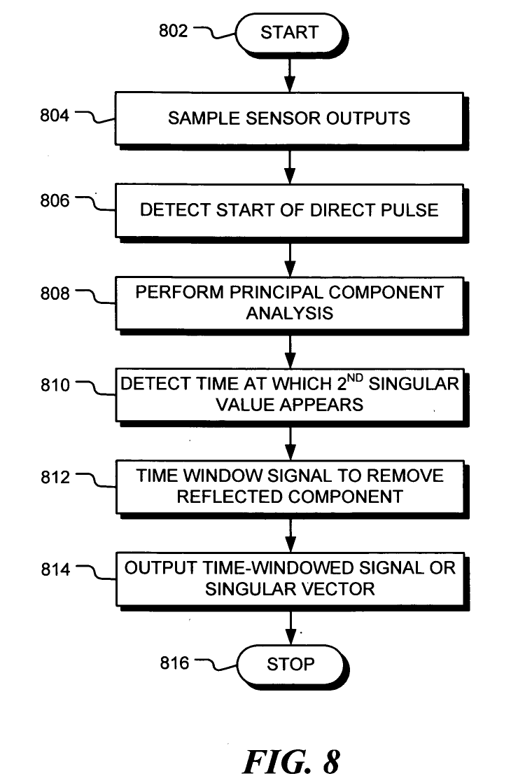

A flow chart of an embodiment of the method is shown in FIG. 8. Following start block 802 in FIG. 8, the signals from a directional sensor (X,Y,Z components for example) are sampled at block 804 to form a sequence of components vectors. The start of an incident sound pulse is detected at block 806. An envelope detector may be used, for example. A principal component analysis of the sequence of component vectors is performed at block 808. This may be done by forming a signal matrix from the component vectors and then performing a singular value decomposition, by performing an eigenvalue analysis on the cross-correlation matrix of the signals, or by performing a PCA using a self adapting network. At block 810, the time at which a second significantly non-zero singular value (or eigenvalue) appears is detected by comparing the first and second largest values. This time approximates the arrival time of the reflected sound wave. At block 812, the signal components are time windowed to remove the components due to the reflected sound wave, and these components are output at block 814 for further analysis. Alternatively, or in addition, the principal component vector (the singular vector corresponding to the largest singular value or the eigenvector vector corresponding to the largest eigenvalue) is output at block 814 as an indication of the acoustic direction. The process terminates at block 816.

In the case where the phase or polarity of the incident pulse is unknown, a signal from a pressure sensor or an omni-directional sensor may be used to determine which way the acoustic wave is propagating along the acoustic direction.

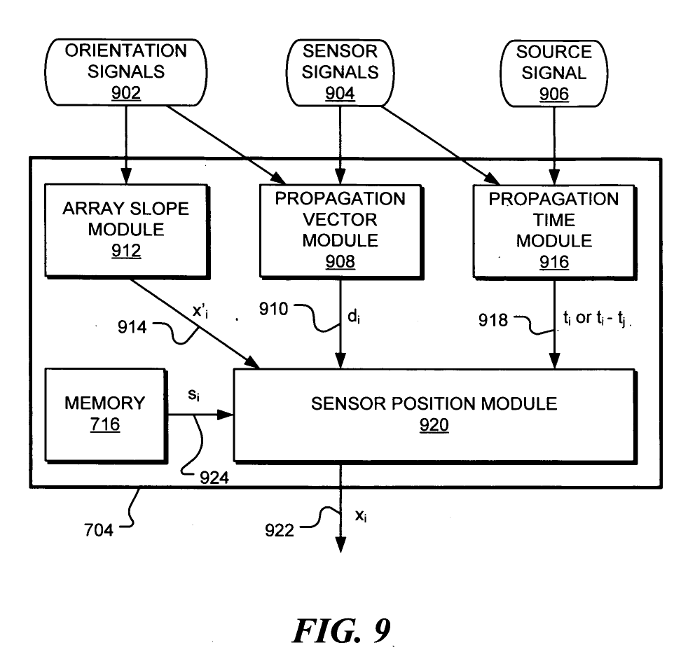

FIG. 9 is a block diagram of a data processor 704 for estimating the shape of an array of connected sensors, in accordance with some embodiments of the invention. In this exemplary embodiment, the data processor 704 has an input for receiving sensor orientation signals or data 902 from the array of connected sensors, an input for receiving sensor signals or data 904 corresponding to a sensed propagating phenomenon, and, optionally, an input for receiving signals or data 906 from a source of the propagating phenomenon. The data processor 704 includes a propagation vector module 908 that is operable to process the sensor orientation data 902 and the sensed data 904, to provide estimates of propagation directions 910 (dᵢ) relative to each sensor of the array of connected sensors.

In some embodiments, the data processor 704 also includes an array slope module 912 that is operable to process the sensor orientation data 902 to determine the slope of the array 914 (x′ᵢ) at each sensor position.

In some embodiments, the data processor 704 also includes a propagation time module 916 that is operable to process the sensed data 904 and the source data 906 to determine the propagation times 918 (tᵢ) from the source to the sensors.

In a further embodiment, for which the source data 906 is unavailable, the propagation time module 916 is operable to process the sensed data 904 to determine the time differences of arrival 918 (tᵢ−tⱼ).

The data processor 704 includes a sensor position module 920 that is operable to estimate the distances from the reference point to each sensor along a corresponding propagation direction and thereby determine the positions 922 (xᵢ), of the connected sensors relative to the reference point. The array processor 920 determines the positions dependent upon the propagation directions 910 and one or more of the slope of the array 914 (x′ᵢ), the propagation times 918 (tᵢ), the time differences of arrival 918 (tᵢ−tⱼ) and the connection lengths 924 (sᵢ) of the connections between the sensors. The connection lengths 924 (sᵢ) may be determined in advance, from measurement for example, and stored in the memory 716. The sensor positions 922 may be output explicitly, or a result dependent upon the positions may be output.

While the invention has been particularly shown and described with reference to a preferred embodiment, it will be understood by those skilled in the art that various changes in form and detail may be made therein without departing from the spirit and scope of the invention.

What is claimed is:

1. A method for estimating the positions of sensors in an array of connected sensors that sense a propagating phenomenon, the method comprising:
for each sensor i in the array of connected sensors:
measuring a direction vector dᵢ corresponding to a direction of propagation of the propagating phenomenon between a reference point and the sensor i; and
estimating the position of the sensor i along the vector dᵢ.

2. A method in accordance with claim 1, wherein estimating the position of the sensor along the direction vector dᵢ comprises estimating the distance between the sensor i and the reference point dependent upon a propagation time between the reference point and the sensor i.

3. A method in accordance with claim 2, wherein the direction vector dᵢ corresponds to a ray path along which the phenomenon propagates between the reference point and the sensor i.

4. A method in accordance with claim 1, wherein estimating the position of the sensor along the direction vector dᵢ comprises fitting a parametric curve between two or more sensors dependent upon the orientations of the sensors and the length of a connector between connected sensors.

5. A method in accordance with claim 1, further comprising generating the propagating phenomenon by activating a source located at the reference point, wherein the sensor comprises a directional sensor.

6. A method in accordance with claim 5, wherein the sensor comprises one or more accelerometers.

7. A method in accordance with claim 1, further comprising generating the propagating phenomenon by activating a source at a sensor position, wherein measuring a direction vector dᵢ comprises measuring the phenomenon using a directional sensor located at the reference point.

8. A method in accordance with claim 7, wherein a sensor in the array of sensors is operated as a source.

9. A method in accordance with claim 1, further comprising measuring gravitational and magnetic field directions relative to the sensor to determine the orientation of the sensor relative to a spatial frame of reference.

10. A computer readable medium containing a program of instructions that, when executed on a data processor, performs a method in accordance with claim 1.

11. A computer readable medium in accordance with claim 10, wherein estimating the positions of the one or more sensors dependent upon the vectors dᵢ is dependent upon a measurement selected from the group of measurements consisting of:
the propagation time of the phenomenon between the reference point and sensor i;
the orientation of sensor i;
the length of a connector between sensor I and an adjacent sensor in a connected array of sensors, and
a time difference of arrival, tᵢ−tⱼ, corresponding to the difference between the propagation time tᵢ between the reference point and the sensor i, and the propagation time tⱼ between the reference point and a sensor j of the one or more sensors.

12. A method for estimating the position, relative to a reference point, of one or more directional sensors that sense a propagating phenomenon, the method comprising:
for each sensor i of the one or more directional sensors:
measuring a direction vector dᵢ corresponding to a direction of propagation of the phenomenon between the reference point and the sensor i in the spatial frame of reference; and
estimating the position of the one or more directional sensors dependent upon the vectors dᵢ, wherein measuring the direction vector dᵢ comprises:
sensing a plurality of directional components of the phenomenon to produce a phenomenon signal for each of the plurality of directional components;
sampling the phenomenon signals to produce a vector of sampled signals for each of the plurality of directional components;
for each of a plurality of time windows:
forming a matrix from the vectors of sampled signals corresponding to a time window of the plurality of time windows;
identifying singular values of the matrix;
selecting a time window for which one of the singular values is significantly larger than the other singular;
determining the direction vector dᵢ from vectors of sampled signals corresponding to the selected time window.

13. A method in accordance with claim 12, wherein determining the direction vector dᵢ comprises identifying the singular vector corresponding to the largest singular value of the matrix formed from the vectors of sampled signals corresponding to the selected time window.

14. A method in accordance with claim 12, further comprising estimating the position of the sensor i along the vector dᵢ.

15. A method in accordance with claim 14, wherein estimating the position of the sensor along the direction vector dᵢ comprises estimating the distance between the sensor and the reference point dependent upon a time difference, tᵢ−tⱼ, between the propagation time tᵢ between the reference point and the sensor i, and the propagation time tⱼ between the reference point and a sensor j of the one or more directional sensors.

16. A method in accordance with claim 14, wherein estimating the position of the sensor along the direction vector dᵢ fitting a parametric curve between two or more sensors dependent upon the orientations of the sensors and the length of a connector between connected sensors.

17. A system for processing data from an array of connected sensors that sense a propagating phenomenon, the system comprising:
an input for receiving sensor orientation data from the array of connected sensors;
an input for receiving sensed data corresponding to a propagating phenomenon;
a data processor comprising:
a propagation vector module that processes the sensor orientation data, and the sensed data, to provide estimates of propagation directions of the propagating phenomenon relative to each sensor of the array of connected sensors; and
a sensor position module that determines the positions of the connected sensors relative to the reference point dependent upon the propagation directions; and
an output for outputting data dependent upon the positions of the connected sensors.

18. A system in accordance with claim 17, wherein the sensor position module determines the positions of the connected sensors dependent upon the slope of the array at each sensor location and a length of a connection between connected sensors.

19. A system in accordance with claim 17, wherein the sensor position module determines the positions of the connected sensors dependent upon the propagation times between the reference point and one or more sensors of the array.

20. A system in accordance with claim 17, wherein the data processor is further operable to estimate the location of the reference point dependent upon the positions of the connected sensors and wherein the data dependent upon the positions of the connected sensors comprises the estimated the location of the reference point.
